(19) United States
(12) Patent Application Publication
(10) Pub. No.: US 2026/0169173 A1
(43) Pub. Date: Jun. 18, 2026

(54) METHODS AND SYSTEM FOR MACHINE LEARNING BASED TUNNEL DETECTION FOR MOBILE GNSS NAVIGATION

(71) Applicant: Samsung Electronics Co., Ltd., Suwon-si (KR)

(72) Inventors: Changwei Chen, San Jose, CA (US); Jong Ki Lee, San Jose, CA (US); Suk Hwan Lim, Los Altos, CA (US)

(21) Appl. No.: 19/319,653

(22) Filed: Sep. 4, 2025

Related U.S. Application Data
(60) Provisional application No. 63/733,925, filed on Dec. 13, 2024.

(51) Int. Cl. G01S 19/24; G01S 19/48

(52) U.S. Cl. CPC G01S 19/24; G01S 19/485

(57) ABSTRACT

A system and a method are disclosed for AI-based tunnel detection, which integrates the application of AI to automatically optimize and control various tunnel detection functions in wireless communication systems utilizing GNSS, and may improve the efficiency and/or accuracy of tunnel detection and GNSS applications. A method may include receiving, at a user equipment (UE) device, a first satellite signal related to a first position of the UE device; applying an Artificial intelligence (AI) model based on the first satellite signal to generate a tunnel detection result; comparing the tunnel detection result to a value generated based on the first satellite signal; determining to disable or enable applying the AI model to a second satellite signal based on the comparing; and executing a function of the UE device to perform estimation of the first position of the UE device based on the tunnel detection result.

### CROSS-REFERENCE TO RELATED APPLICATION

This application claims the priority benefit under 35 U.S.C. § 119(e) of U.S. Provisional Application No. 63/733925, filed on Dec. 13, 2024, the disclosure of which is incorporated by reference in its entirety as if fully set forth herein.

### BACKGROUND

### 1. Field

Aspects of some embodiments of the present disclosure generally relate to wireless communication systems. More particularly, the subject matter disclosed herein relates to global navigation satellite system (GNSS) including tunnel detection using artificial intelligence (AI).

### 2. Description of the Related Art

Global Navigation Satellite System (GNSS) is a technology that uses a network of orbiting satellites to provide positioning, navigation, and timing (PNT) information to users on and/or near the Earth's surface. GNSS technology involves a constellation of satellites that provides autonomous geo-spatial positioning, navigation, and timing services worldwide. Satellites transmit signals that GNSS receivers can use in order to calculate position, velocity, and time by measuring the time it takes for the signals to travel from the satellites to the receiver, for example. By utilizing signals from multiple GNSS systems, receivers can achieve improved accuracy, for instance in challenging environments such as urban areas where signals from a single system might be blocked.

Tunnel detection involves the identification of instances when a receiver is operating within a tunnel or other underground structure where satellite signals may be blocked or degraded. Tunnel detection can be an important aspect in GNSS technology, because with GNSS signals being transmitted from satellites in space, tunnels often interfere with the signal reception by receivers, and may cause inaccurate or lost positioning data. For example, when a GNSS receiver enters a tunnel, it may lose the direct line of sight to the GPS satellites, resulting in a loss of signal and inaccurate positioning. Without accurate positioning, navigation systems can fail, potentially leading users off course or causing them to miss exits or turns. In applications like autonomous vehicles or emergency response, inaccurate positioning within a tunnel can pose significant safety risks.

The robustness and/or efficiency of Artificial Intelligence (AI) techniques have not been leveraged for tunnel detection, in accordance with some wireless communication technology standards, in a manner that ensures flexibility, reliability, and high-accuracy for a wide-range of GNSS applications and user devices.

The above information disclosed in this Background section is for enhancement of understanding of the background of the present disclosure, and therefore, it may contain information that does not constitute prior art.

### SUMMARY

Aspects of some embodiments of the present disclosure generally relate to integrating AI-based models, functions, and techniques for tunnel detection, in accordance with some wireless communication technology standards, in a manner that may improve flexibility, reliability, and high-accuracy for a wide-range of GNSS applications and user devices. In some embodiments, a method may include receiving, at a user equipment (UE) device, a first satellite signal. The satellite signal may be related to a first position of the UE device. The method may further include applying an AI model based on the first satellite signal to generate a tunnel detection result corresponding to the first position of the UE device; comparing the tunnel detection result to a value generate based on the first satellite signal; determining to disable or enable applying the AI model to a second satellite signal based on the comparing, where the second satellite signal is received by the UE device and related to a second position of the UE device; and executing a function of the UE device to perform estimation of the first position of the UE device based on the tunnel detection result.

In some embodiments, the value may correspond to an output from a tunnel detection operation performed based on applying a threshold to the first satellite signal, and the tunnel detection result may correspond to classifying the first position of the UE device as inside of a tunnel or may correspond to classifying the first position of the UE device as outside of the tunnel based.

In some embodiments, determining to disable applying the AI model to the second satellite signal may be based on the comparing indicating a convergence of the tunnel detection result and the value.

In some embodiments, the AI model may be trained on a plurality of Global Navigation Satellite System (GNSS) signal metrics related to the first satellite signal, and the GNSS signal metrics may include one or more L1 GNSS signal metrics and one or more L5 GNSS signal metrics.

In some embodiments, the first satellite signal and the second satellite signal may include a GNSS signal transmitted from a satellite.

In some embodiments, the AI model may be trained to classify stages of tunnel detection corresponding to the first position of the UE device, and the stages of tunnel detection may include one or more of: entering a tunnel, inside of a tunnel, and exiting a tunnel.

In some embodiments, the first satellite signal and the second satellite signal may be related to a GNSS application of the UE device.

In some embodiments, the GNSS application of the UE device may include Global Positioning System (GPS) navigation.

In some embodiments, the method may further include executing an additional function of the UE device to perform GPS navigation using a camera of the UE device or a sensor of the UE device based on the tunnel detection result indicating that the first position of the UE device corresponds to inside of a tunnel.

In some embodiments, determining to enable applying the AI model to the second satellite signal may be based on the comparing indicating a divergence of the tunnel detection result and the value.

In some embodiments, the threshold may be a set number of satellites used to transmit the first satellite signal.

In some embodiments, the threshold may be a set signal strength of the first satellite signal.

Aspects of some embodiments of the present disclosure generally relate to a device, including: a processor; and a memory storing instructions that, based on being executed by the processor, cause the processor to: receive a first satellite signal, the satellite signal may be related to a first position of a the device; apply an AI model based on the first satellite signal to generate a tunnel detection result corresponding to the first position of the device; compare the tunnel detection result to a value generate based on the first satellite signal; determine to disable or enable applying the AI model to a second satellite signal based on the comparing, the second satellite signal may be received by the device and related to a second position of the device; and execute a function of the device to perform estimation of the first position of the device based on the tunnel detection result.

In some embodiments, the device may be a User Equipment (UE) device.

In some embodiments, the value may correspond to an output from a tunnel detection operation performed based on applying a threshold to the first satellite signal; and further the tunnel detection result may correspond to classifying the first position of the UE device as inside of a tunnel or may correspond to classifying the first position of the UE device as outside of the tunnel based.

In some embodiments, the AI model may be trained on a plurality of GNSS signal metrics related to the satellite signal.

In some embodiments, the GNSS signal metrics comprise one or more L1 GNSS signal metrics and one or more L5 GNSS signal metrics.

In some embodiments, the first satellite signal and the second satellite signal may include a GNSS signal transmitted from a satellite.

In some embodiments, the first satellite signal and the second satellite signal may be related to a GNSS application of the UE device.

Aspects of some embodiments of the present disclosure generally relate to a device, system, including: a receiver communicating with a GNSS satellite; a processing circuit; and a memory device storing instructions, which, based on being executed by the processing circuit, cause the processing circuit to perform: receiving a first satellite signal, the first satellite signal may be related to a first position of a the device; applying an AI model based on the first satellite signal to generate a tunnel detection result corresponding to the first position of the device; comparing the tunnel detection result to a value generate based on the first satellite signal; determining to disable or enable applying the AI model to a second satellite signal based on the comparing, the second satellite signal may be received by the device and related to a second position of the device; and executing a function of the device to perform estimation of the first position of the device based on the tunnel detection result.

### BRIEF DESCRIPTION OF THE DRAWINGS

In the following section, the aspects of the subject matter disclosed herein will be described with reference to exemplary embodiments illustrated in the figures.

FIG. 1 illustrates an example wireless network system implementing Artificial Intelligence (AI)-based tunnel detection, according to some embodiments of the present disclosure.

FIG. 2A is a block diagram illustrating an example user equipment (UE) device for AI-based tunnel detection implementing a tunnel detection circuit that includes AI-based tunnel detection circuity, according to some embodiments of the present disclosure.

FIG. 2B depicts an example of an AI model and related data that may be implemented for AI-based tunnel detection, according to some embodiments of the present disclosure.

FIG. 2C depicts an example of geofences for tunnel data labeling that may be implemented for AI-based tunnel detection, according to some embodiments of the present disclosure.

FIG. 3A is a flowchart illustrating a method implementing AI-based tunnel detection, according to some embodiments of the present disclosure.

FIG. 3B is a flowchart illustrating another example method for implementing an integrated AI-based tunnel detection, according to some embodiments.

FIG. 3C is a flowchart illustrating another example method for implementing an integrated AI-based tunnel detection, according to some embodiments.

FIG. 4 illustrates a system including a UE and a general Nodes B (gNB) in communications with each other.

FIG. 5 is a block diagram of an electronic device in a network environment, according to one or more embodiments of the present disclosure.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in some embodiments (e.g., in one or more embodiments). In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

Aspects of some embodiments of the present disclosure may provide AI-based tunnel detections methods and systems that may leverage AI capabilities to provide improved accuracy, flexibility, and efficiency in tunnel detection for GNSS applications, such as Global Positioning System (GPS) navigation. GNSS may rely on a direct line-of-sight to satellites to accurately determine a receiver's position. When a device utilizing GNSS is inside of a tunnel and/or other physical structure, these GNSS signals may be physically blocked, rendering some GNSS solutions ineffective. In some embodiments, AI-based tunnel detection circuitry is provided that implements AI functions in order to accurately and efficiently detect tunnel entry and/or tunnel exit of a mobile device, in scenarios where the reliability and/or accuracy of other tunnel detection (non-AI) operations (based on static, pre-defined approaches) may be restricted and/or negatively impacted. In some embodiments, an AI-based tunnel detection model is created, trained, and utilized that is distinctly trained using various GNSS signal metrics for tunnel detection, for example a model training process (e.g., larger data sets, data from longer tunnels, etc.) that enhances the accuracy and/or efficiency of the tunnel detection results over tunnel detection (non-AI) operations.

Embodiments of the present disclosure may be directed to systems and methods to implement AI-based tunnel detection, which modifies the application of AI to automatically optimize and control various tunnel detection functions in wireless communication systems utilizing GNSS. Thus, some embodiments of the present disclosure may improve the efficiency and/or accuracy of tunnel detection, thereby improving the overall performance of a wireless communication network utilizing GNSS applications, through achieving an optimized integration of AI for tunnel detection.

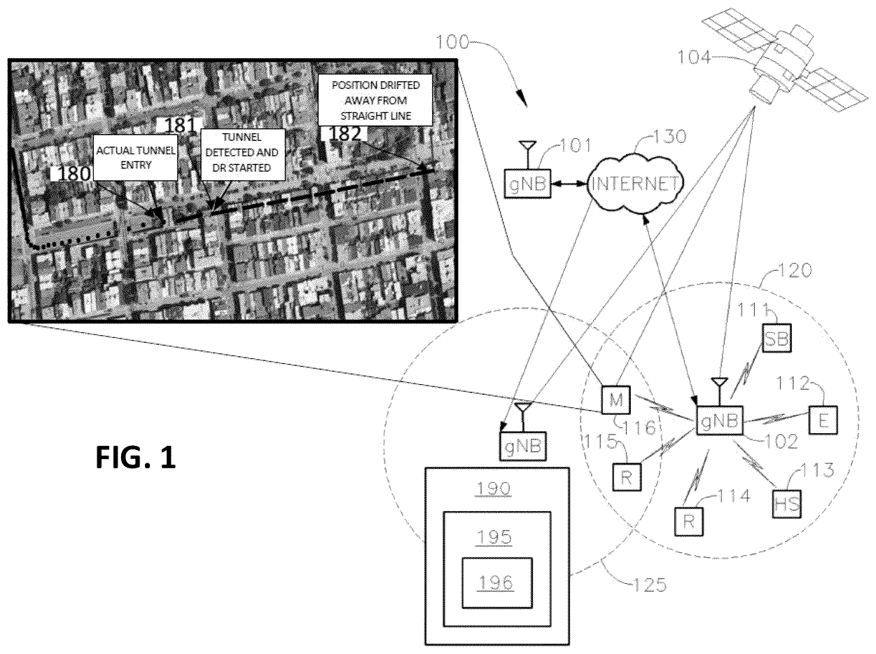

FIG. 1 illustrates an example wireless network according to embodiments of the present disclosure. The wireless network shown in FIG. 1 also illustrates the mobile device 190 that may be configured for implementing AI-based tunnel detection, as disclosed herein. Other embodiments of the wireless network 100 could be used without departing from the scope of this disclosure. Further, while only a small number of satellites, data networks, nodes, components, devices, user equipments (UEs), etc. are shown in FIG. 1 for illustrative purposes only, those of ordinary skill in the art would appreciate that the number of satellites, data networks, nodes, components, devices, UEs, etc. are not necessarily limited to those shown in FIG. 1 but can be expanded to encompass a plurality of the same, similar and/or other suitable satellites, data networks, nodes, components, devices, UEs, etc.

As shown in FIG. 1, the wireless network may include a gNB 101 (e.g., base station, BS), a gNB 102, and a gNB 103. The gNB 101 may communicate with the gNB 102 and the gNB 103. The gNB 101 may also communicate with at least one network 130, such as the Internet, a proprietary Internet Protocol (IP) network, and/or other data network.

The gNB 102 may provide wireless broadband access to the network 130 for a first plurality of user equipments (UEs) within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and UE 116, which may be a mobile device (M), such as a cell phone, a wireless laptop, a wireless PDA, or the like, and a UE 190 which may be a mobile device that is configured to execute one or more GNSS applications, such as a cell phone with (Global Positioning System) navigation. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116, and 190 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in the present disclosure to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in the present disclosure to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As described in more detail below, one or more of the UEs 111-116, 190 include circuitry, programing, or a combination thereof for supporting global navigation satellite system (GNSS) operations and/or applications in a wireless communication system 100, for example having the capability to communicate with satellite 104. In the example of FIG. 1, satellite 104 can operate within a constellation of satellites for GNSS that provide autonomous geo-spatial positioning, navigation, and timing services worldwide. Furthermore, UEs 116 and 190 may be configured to have a receiver that operates as a GNSS receiver that processes the signals from GNSS satellites including satellite 104. Satellite 104 may transmit signals that the GNSS receivers of UEs 116, 190 utilize to calculate their position, velocity, and time by measuring the time it takes for the signals to travel from the satellite 104 to the respective receivers. Accordingly, UEs 116, 190 may execute applications and/or functions that provide navigation, device position, and/or device movement features that are supported using GNSS technology, such as, for example, GPS navigation.

In applications that utilize GNSS technology, tunnel detection is an important (e.g., essential) feature that supports the ability of the device and/or system to identify when a receiver is operating within a tunnel or other structure (e.g., under bridges/overpasses, underground bore, mines, etc.) where satellite signals may be blocked and/or degraded. This is very important (e.g., crucial) because GNSS signals are typically transmitted from satellites in space, such as satellite 104, and tunnels may interfere with the signal reception, causing inaccurate, delayed, and/or lost navigation (e.g., positioning data). Furthermore, there may be a potential that the detection of a tunnel may be completely missed (e.g., short amount time in a tunnel) which may result in using the corrupted GNSS measurement without any protection and/or corrective measures.

In the example of FIG. 1, UE 190 includes a tunnel detection circuit 195 that implements AI-based tunnel detection circuitry 196, programing, or a combination thereof, for supporting enhanced tunnel detection operations. Accordingly, the tunnel detection circuit 195 of the UE 190 is configured to leverage AI capabilities in tunnel detection operations in a manner that improves the accuracy and/or efficiency of the GPS applications and/or other applications using GNSS technology. Furthermore, in the example of FIG. 1, the UE 116 may be configured to execute an GPS application that implements tunnel detection that may not utilize AI capabilities.

When UE 116 enters a tunnel, it may lose the direct line of sight to the satellite 104, resulting in a loss of signal and inaccurate positioning. Without accurate positioning, navigation systems can fail, potentially leading users off course or causing them to miss exits or turns. Such inaccurate position and velocity estimates will become the initial conditions for the vehicle dead-reckoning (VDR) mode and thus may further degrade the navigation if the tunnel is lately detected. FIG. 1 illustrates an operational example of the GPS application of the UE 116 that may not utilize AI capabilities. In the example of FIG. 1, the UE 116 may enter a tunnel at a point 180 (actual tunnel entry). However, because the UE 116 may not be configured to utilize AI based tunnel detection, as disclosed herein, the GPS technology may experience delays which can cause the tunnel to not be detected until a later point 181. At point 181, when the tunnel is detected, the dead reckoning may begin, but the UE 116 has already entered the tunnel (e.g., currently moving through tunnel). There may be a substantial lapse between the time/position of the UE 116 at the detected tunnel entry (at point 181) and the previous time/position of the UE 116 when it physically entered the tunnel (at point 180). The delayed tunnel detection at point 181 may result in bad initial conditions (e.g., loss of satellite signals) for the dead-reckoning inside of the tunnel, which can cause inaccurate GPS positioning afterwards as the UE 116 continues to move. For example, at point 182 the detected position for UE 116 based on the delayed dead-reckoning has drifted away from the actual position (along the dotted line) of the UE 116.

In some existing applications that utilize GNSS technology, like autonomous vehicles or emergency response, inaccurate positioning within a tunnel can pose significant safety risks. As a general description, the UE 116 may implement tunnel detection (non-AI) operations by utilizing the acquisition of real-time data associated with GNSS signals obtained by its receiver and static rules, defined thresholds, and policies to detect the weakening or loss of satellite signals as a tunnel entrance is approached. For example, tunnel detection (non-AI) operations of UE 116 may involve determining whether the strength and/or quality of GNSS signals has decreased by a determined amount, for instance a predefined, static, defined threshold, in order to determine that the UE 116 may be in a tunnel.

In some embodiments, tunnel detection operations may be based on the underlying principle that a sudden decrease and/or degradation of the GNSS signal indicates that there is a potential physical block of the signal, for example due to entry into a tunnel; and an instantaneous (e.g., sudden) increase and/or improvement of the GNSS signal indicates that there is a potentially no block of the signal, such as in an open sky after exiting tunnel. Accordingly, other factors related to speed, positioning, and/or the like may impact the ability and/or accuracy of tunnel detection. For example, if the UE 116 is moving at a high rate of speed, then the quick drop of the GNSS signal strength, due to entering a tunnel, may be detected. However, in cases when the UE 116 may be moving at a relatively slower rate of speed, then the decrease of GNSS signal strength, for example, may seemingly be gradual and thus may not be attributed to entering a tunnel, based on the static tunnel detection (non-AI) operations of UE 116.

The UE 190 includes a tunnel detection circuit 195 that implements AI-based tunnel detection circuitry 196 utilizing trained AI models that can be applied to tunnel detection operations, rather than relying on static and/or pre-defined rules, policy, and defined thresholds and raw data (e.g., a small set of real-time GNSS signals obtained from satellite 104 while UE 116 is in the tunnel). The AI-based models that are generated, trained, and applied by the AI-based tunnel detection circuitry 196 may be trained using substantially large data sets that are obtained. For example, training data may be obtained from devices that are traversing long tunnels (e.g., length of approximately 800 meters and/or greater) in order to collect large amounts of data that may be analyzed to recognize patterns in the behavior and/or characteristics of the GNSS signals (with respect to position of the tunnel) over time. Therefore, the AI-based tunnel detection circuitry 196 may be able to apply AI-based models, that have been distinctly trained for leveraging AI inferencing to detect trends, GNSS metrics, and/or other pertinent data for tunnel detection, to the real-time data associated with GNSS signals that are obtained by the UE 190 from satellite 104, for example, while it is moving through a tunnel. By utilizing the AI-based tunnel detection circuitry 196, as opposed to static, defined thresholds (e.g., tunnel detection (non-AI) operations of UE 116), the UE 190 may perform tunnel detection operations having improved accuracy and/or efficiency. For example, the GPS navigation application of UE 190 may perform navigation through a tunnel (e.g., estimating the location of UE 190 as it moves through the tunnel) with increased accuracy and improved safety, by implementing AI-based tunnel detection, as disclosed herein.

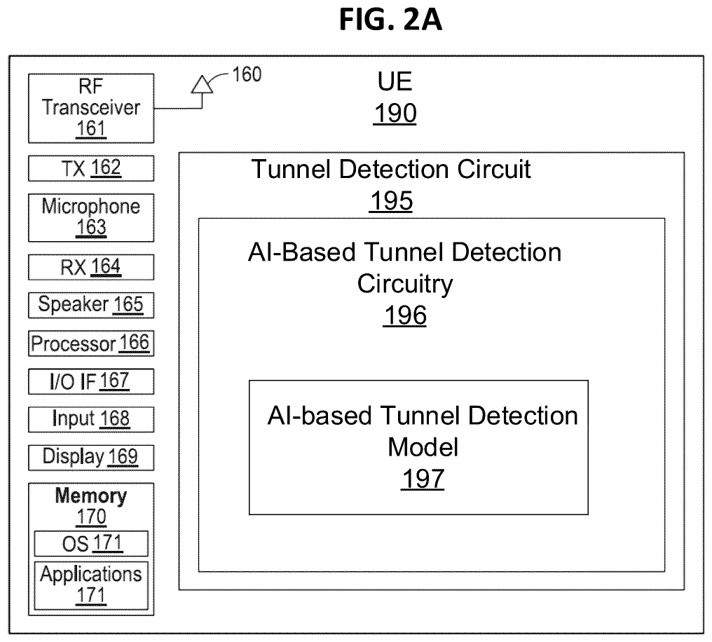

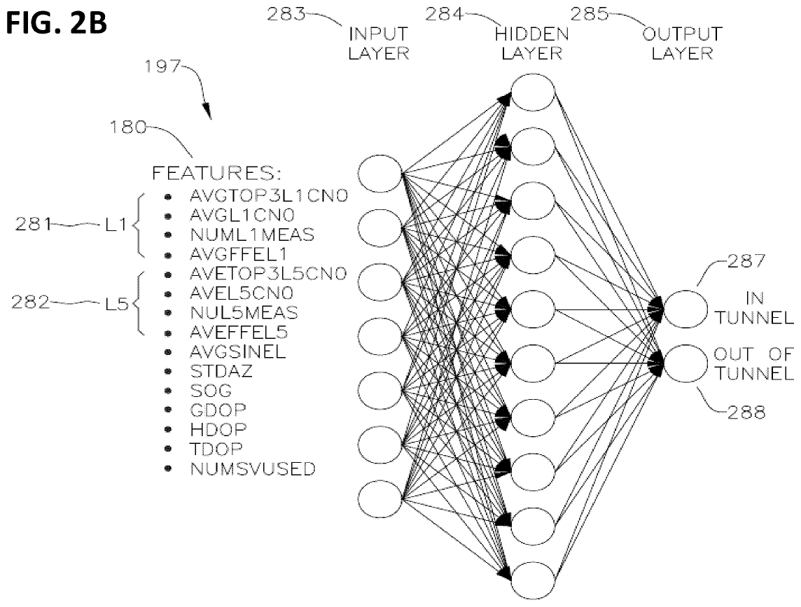

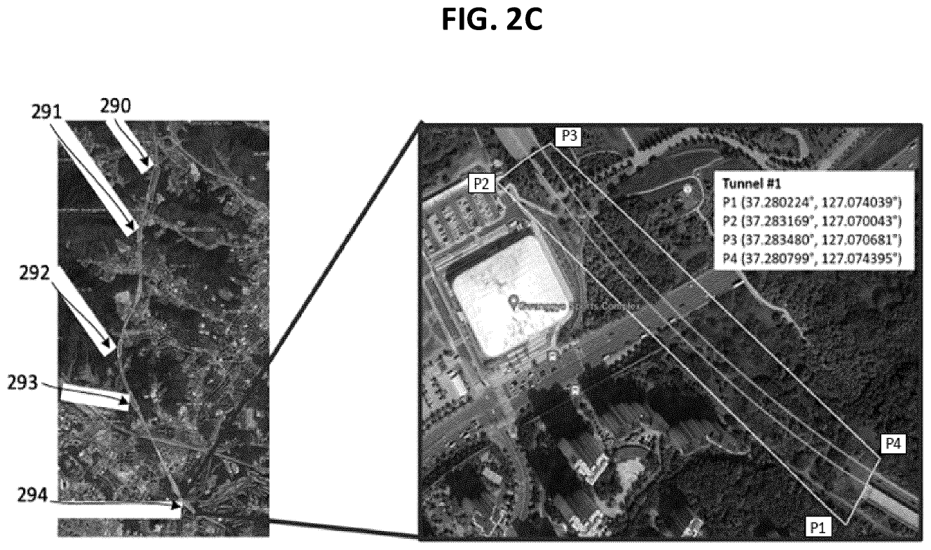

FIG. 2A is a block diagram illustrating an example UE 190 for AI-based tunnel detection, implementing a tunnel detection 195 circuit and AI-based tunnel detection circuitry 196, according to some embodiments of the present disclosure. Although FIG. 2A illustrates a UE 190 for implementing AI-based tunnel detection according to some embodiments, there are embodiments according to the present disclosure that are not limited thereto. For example, according to some embodiments, the functions and/or capabilities of the tunnel detection 195 circuit and AI-based tunnel detection circuitry 196 may be implemented in various other wireless devices, mobile devices, vehicles, and/or other GNSS-equipped device, without departing from the spirit and scope of embodiments according to the present disclosure.

As illustrated in FIG. 2A, an example configuration of the UE 190 (e.g., see FIG. 1) may include multiple hardware and/or software components implementing capabilities related to AI-based tunnel detection. The UE 190 depicted in FIG. 2A is not intended to be limiting, and the related structure and/or functions of the component may be implemented in a wide variety of configurations, without departing from the scope of the present disclosure. For example, in some embodiments, a gNB (e.g., gNB 102 shown in FIG. 1) may be configured with similar hardware and/or software components to implement the capabilities related to AI-based tunnel detection, as described herein with reference to FIG. 2A.

As shown in FIG. 2A, the UE 190 may include an antenna 160, a radio frequency (RF) transceiver 161, TX processing circuitry 162, a microphone 163, and RX processing circuitry 164. The UE 190 may also include a speaker 165, a processor 166, an input/output (I/O) interface (IF) 167, an input device 168, a display 169, and a memory 170. The memory 170 may include an operating system (OS) 171 and one or more applications 172. In some embodiments, applications 172 may include capabilities that include GNSS technology, for example GPS navigation.

The RF transceiver 161 may receive from the antenna 160, an incoming RF signal transmitted by a gNB (e.g., gNB 102 in FIG. 1) of the network 100. The RF transceiver 161 may down-convert the incoming RF signal to generate an intermediate frequency (IF) or baseband signal. The IF or baseband signal can be sent to the RX processing circuitry 164, which may generate a processed baseband signal by filtering, decoding, and/or digitizing the baseband or IF signal. The RX processing circuitry 164 may transmit the processed baseband signal to the speaker 165 (such as for voice data) or to the processor 166 for further processing (such as for web browsing data).

The TX processing circuitry 162 may receive analog or digital voice data from the microphone 163 or other outgoing baseband data (such as web data, e-mail, or interactive video game data) from the processor 166. The TX processing circuitry 162 may encode, multiplexes, and/or digitizes the outgoing baseband data to generate a processed baseband or IF signal. The RF transceiver 161 may receive the outgoing processed baseband or IF signal from the TX processing circuitry 162 and can up-convert the baseband or IF signal to an RF signal that is transmitted via the antenna 160.

The processor 166 may include one or more processors or other processing devices, and may execute the OS 171 stored in the memory 170 in order to control the overall operation of the UE 190. For example, the processor 166 may control the reception of forward channel signals, and the transmission of reverse channel signals by the RF transceiver 161, the RX processing circuitry 164, and the TX processing circuitry 162. In some embodiments, the processor 166 may include at least one microprocessor or microcontroller.

The processor 166 may also be capable of executing other processes and programs resident in the memory 170 and related to the functions of the tunnel detection circuit 195, including AI-based tunnel detection functions. The processor 166 may move data into or out of the memory 170 as required by an executing process.

In some embodiments, the processor 166 may execute the applications 172 based on the OS 171 or in response to signals received from gNBs or an operator. The processor 166 may also be coupled to the I/O interface 167, which provides the UE 190 with the ability to connect to other devices, such as laptop computers and handheld computers. The I/O interface 167 may provide the communication path between these accessories and the processor 166.

The processor 166 may also be coupled to the input device 168 and the display 169. The operator of the UE 190 may use the input device 168 to enter data into the UE 190. The input device 168 may be a keyboard, touchscreen, mouse, track ball, voice input, or other device capable of acting as a user interface to allow a user in interact with the UE 190. For example, the input device 168 may include voice recognition processing, thereby allowing a user to input a voice command. In another example, the input device 168 may include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme.

The processor 166 may also be coupled to the display 169. The display 169 may be a liquid crystal display, a light emitting diode display (e.g., an organic light emitting diode (OLED) display or a micro light emitting diode (LED) display), or other suitable display capable of rendering text and/or at least limited graphics, such as from web sites.

The memory 170 may be coupled to the processor 166. Part of the memory 170 may include a random-access memory (RAM), and another part of the memory 360 may include a Flash memory and/or a read-only memory (ROM). In some embodiments, the memory 170 may store data (e.g., GNSS metrics, etc.) associated with functions for AI-based tunnel detection, as disclosed herein. In some embodiments, the memory 170 may store data, instructions, and/or AI models (e.g., AI-based tunnel detection model 197) utilized by the tunnel detection circuit 195 and AI-based tunnel detection circuitry 196.

In some embodiments, the tunnel detection circuit 195 may be configured to implement functions related to tunnel detection (non-AI) operations and/or AI-based tunnel detection operations, as disclosed herein. For example, the tunnel detection circuit 195 may be configured to implement tunnel detection, for example automatically determining that the UE 190 is at a position that is in a tunnel, as GNSS technology relies on line-of-sight to satellites, which may be blocked underground (e.g., GNSS signals may not penetrate through a tunnel wall and/or other structures). In some embodiments, functions and/or information from the tunnel detection circuit 195 can be integrated with other systems of the UE 190 in order to maintain and/or provide positioning and navigation capabilities when GNSS signals are unavailable (e.g., blocked, attenuated, etc.) due to being obstructed by the tunnel. For example, the tunnel detection circuit 195 may be configured to trigger the UE 190 to automatically adjust settings of the UE 190 to perform estimation of the position of the UE 190 without GNSS signals based on the tunnel detection circuit 195 detecting that the UE 190 is inside of a tunnel, and/or executing additional functions (e.g., enable cameras and/or other sensors) to continue navigation for the UE 190 based on the tunnel detection circuit 195 detecting that the UE 190 is inside of a tunnel.

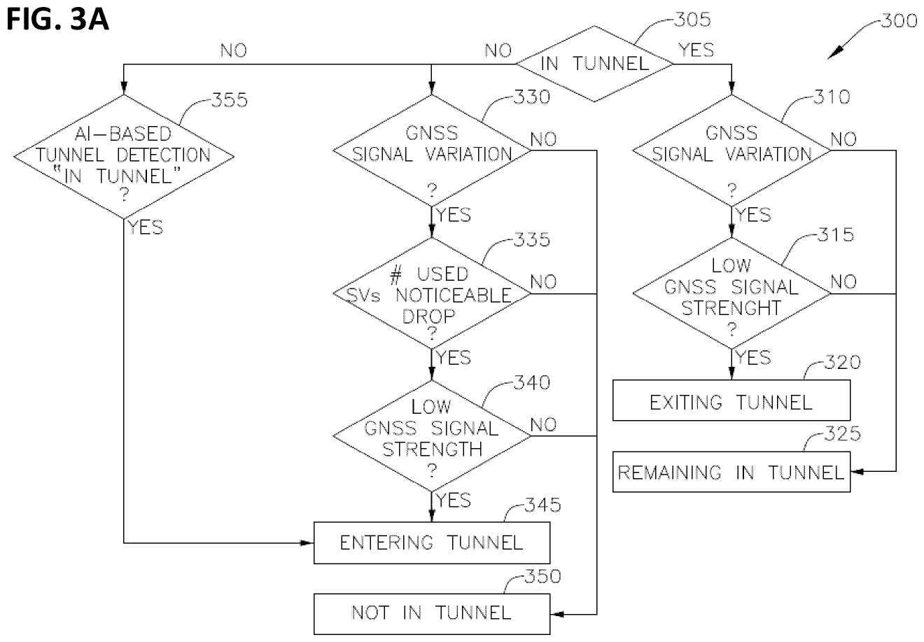

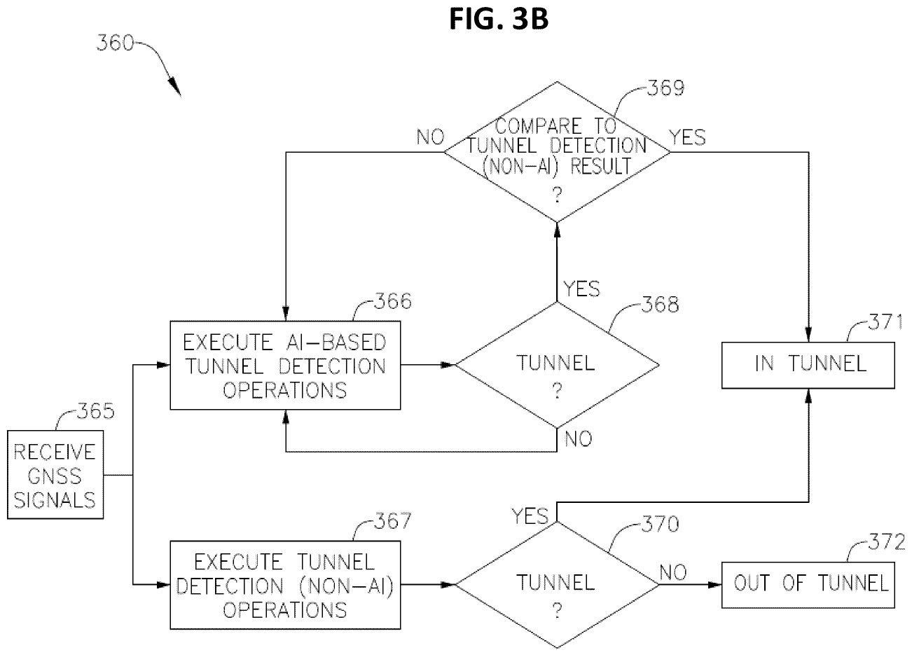

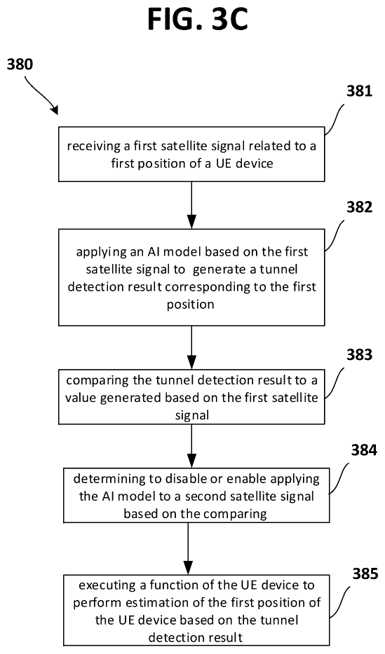

For example, the tunnel detection circuit 195 may be configured to perform various functions relating to tunnel detection, including but not limited to: detecting presence of a tunnel; determining (e.g., classifying) position and/or phases of the UE 190 with respect to the tunnel (e.g., entry detection, inside tunnel, exit detection); reinitialization and/or revalidation of position (e.g., during GNSS outage); calculations and/or determinations related to GNSS signal metrics and/or quality (e.g., carrier-to-noise density ratio, satellite visibility count, signal power, position fix type, average satellite signal strength, etc.); calculations and/or determinations related to sensor measurements (accelerometers, gyroscopes, etc.); calculations and/or measurements related to position, motion, and/or orientation of the UE 190 (e.g., speed/acceleration, angular velocity, etc.); calculations and/or measurements related to time and/or temporal parameters (e.g., time inside of tunnel, etc.); tunnel detection (non-AI) operations based on rules, defined thresholds, policies, etc. ; and/or the like. Examples of functions that may be implemented by the tunnel detection circuit 195 are described in greater detail below in reference to FIG. 3, for example.

In some embodiments, the tunnel detection circuit 196 may include AI-based tunnel detection circuitry 196 that may be configured to execute one or more functions related to the AI-based tunnel detection. For example, the AI-based tunnel detection circuitry 196 may be configured to generate, train, and utilize an AI-based tunnel detection model 197 that is trained to predict a classification for the position of a UE 190, for example in tunnel/out of tunnel, based on GNSS signal metrics. For example, the AI-based tunnel detection circuitry 196 is configured to predict whether the UE 190 may be entering a tunnel, inside of a tunnel, exiting a tunnel, and/or the like by leveraging AI inferencing capabilities for models that have been trained to observe the patterns in the GNSS signal metrics associated with the classification (inside of a tunnel, exiting a tunnel, etc.) over time. Accordingly, functions of the AI-based tunnel detection circuitry 196 may provide more accurate (e.g., reduced false alarms, reduced missed detections, etc.) and efficient (e.g., early entering a tunnel detection) tunnel detection capabilities for the UE 190. For example, the AI-based tunnel detection circuitry 196 may provide accurate tunnel detection in cases when the UE 190 may be traveling through a short tunnel and the interruption to the GNSS signals may be too brief to reliably detect based on other tunnel detection (non-AI) operations; and in cases when the UE 190 may be traveling at a slower speed (e.g., traffic) that may impact the reliably of detection based on other tunnel detection (non-AI) operations. An example of the AI-based tunnel detection model 197 that may be generated, trained, and/or utilized by the AI-based tunnel detection circuitry 196 for implementing the AI-based tunnel detection functions of the UE 190 is illustrated in FIG. 2B.

FIG. 2B illustrates an example of the AI-based tunnel detection model 197 as a neural network model. As a general description, the AI-based tunnel detection model 197 can be trained using a plurality of GNSS signal metrics as input features 280 to learn the pattern in the data over time, and generate predictions and/or classifications of the GNSS signals based on the pattern recognition, for example classifying observed GNSS signals as being in the “in tunnel” classification 388 or being in the “out tunnel” classification 389.

The AI-based tunnel detection model 197 may be configured to receive a plurality of GNSS signal metrics as input features 280, which are the measurable characteristics and/or variables of the GNSS signal data that the AI-based tunnel detection model 197 learns from to make predictions. In the example of FIG. 2B, the input features 280 may include one or more L1 GNSS metrics 281 that are based on L1 GNSS signals, which are the original and most widely used signals for GNSS applications and may be transmitted at a frequency of approximately 1575.42 MHz; and one or more L5 GNSS metrics 282 that are based on L5 GNSS signals, which are signals that may be configured as GPS signals for high-accuracy and high-precision positioning and may be transmitted at a frequency of approximately 1176 MHz.

In the example of FIG. 2B, the L1 GNSS metrics 281 may include: AvgTop3L1CNO (e.g., average of the carrier-to-noise density ratio (C/N0) values for the top 3 satellites tracked on the L1 frequency band); AvgL1CNO (e.g., average Carrier-to-Noise Density (C/N0) of the L1 signals); NumL1Meas (e.g., number of measurements made on the L1 frequency); and AvgFFEL1 (e.g., average Filtered Frequency Error on the L1 frequency band). In the example of FIG. 2B, the L5 GNSS metrics 282 may include: AvgTop3L5CNO (e.g., average of the carrier-to-noise density ratio (C/N0) values for the top 3 satellites tracked on the L5 frequency band); AvgL5CNO (e.g., average Carrier-to-Noise Density (C/N0) of the L5 signals); NumL5Meas (e.g., number of measurements made on the L5 frequency); and AvgFFEL5 (e.g., average Filtered Frequency Error on the L5 frequency band). In the example of FIG. 2B, other GNSS signal metrics that may be utilized as input features 280 may include: AvgSineI (e.g., average Sine of elevation angle of satellites); StdAz (e.g., standard deviation of the Azimuth angle of satellites); Sog (e.g., speed over ground); GDOP (e.g., Geometric Dilution of Precision); HDOP (e.g., Horizontal Dilution of Precision); TDOP (e.g., Time Dilution of Precision); and NumSVUsed (e.g., number of satellites used by a receiver to calculate its position, velocity, and time solution).

The input features 280 may be fed into the input layer 283 of the AI-based tunnel detection model 197, where the input layer 283 may be configured to receive the raw features values and pass them into the neural network. Each node (or neuron) of the input layer 283 may correspond to one input feature, in some embodiments. Additionally, in some embodiments, each of the features 280 can be calculated in an epoch, which can enable the AI-based tunnel detection model 197 to perform a calculation for every example of the features 280 in the training data in a full cycle (or epoch) of the training phase and update the parameters based on the learning from those examples.

The input layer 283 may distribute the values of the input features 280 into the hidden layer 284, which transforms the input using weighted connections and non-linear activation functions. Accordingly, the AI-based tunnel detection model 197 may be configured to extract patterns, relationships, and features related to the observed behavior of GNSS signals, with respect to being inside of a tunnel and/or outside of a tunnel, from the input features 280. In some embodiments, the hidden layer 284 includes multiple layers. Thereafter, the output layer 285 may be configured to generate the final prediction and/or classification of the AI-based tunnel detection model 197. For example, the AI-based tunnel detection model 197 may be trained to detect whether the GNSS signals that are being currently obtained by the UE 190 are classified as “in tunnel” 287 indicating that the model 197 is predicting that the UE 190 is at a position inside of a tunnel, or to detect whether the GNSS signals that are being currently obtained by the UE 190 are classified as “out of tunnel”288 indicating that the model 197 is predicting that the UE 190 is at a position outside of a tunnel. Accordingly, the AI-based tunnel detection model 197 can be trained to learn patterns related to tunnel detection from GNSS signal metrics and improve over time in a manner that provides accurate and/or efficient tunnel prediction without being explicitly programmed, such as in the case with static, pre-defined rules, defined thresholds, and policies that may be utilized for tunnel detection (non-AI) operations of the tunnel detection circuit 195.

FIG. 2C depicts an example of data labeling that may be utilized for implementing the AI-based tunnel detection model 197 (shown in FIG. 2B). As used herein, “data labeling” may refer to the process of assigning information tags and/or annotations to raw data, which may enable an AI model to be trained to infer classifications for other examples and/or data (e.g., during inference) based on the learned correspondences extracted from the labeled examples (e.g., during training).

FIG. 2C illustrates image data labeling that may involve assigning labels (e.g., “in tunnel” or “out of tunnel”) to individual data points within an image. The labels can then provide the “ground truth” (e.g., correct classification for a data point) for an AI model to learn from. Image data labeling can include providing bounding boxes around the objects of interest in an image and labeling them. For example, as illustrated in FIG. 2C, data used for data labeling and training may be images derived from field tests that are conducted in one or more areas that include tunnels and/or similar structures, where the data points may be obtained from the geofencing. FIG. 2C depicts multiple bounding boxes 290-294 that can be positioned around the identified tunnel areas in the images of the test field, such that each of the bounding boxes 290-294 (corresponding to the tunnel areas) in the image data can have a corresponding label (e.g., “in tunnel” labels). The labeled data, including the bounding boxes 290-294 labeled as “in tunnel”, can then become the training dataset used to train the AI-based tunnel detection model 197. During the training of the AI-based tunnel detection model 197, when a data point is analyzed that corresponds to a location inside one of the bounding boxes 290-294 it may be considered a “ground truth” and labeled “in tunnel”. The AI-based tunnel detection model 197 can then be trained based on the “ground truth” to assign the features related to GNSS signal metrics (e.g., input features 280 in FIG. 2B) that correspond to the position (data point) to the classification of “in tunnel”. Other data points that correspond to locations in the image that are outside of the bounding boxes 290-294, representing the areas that do not have tunnels, may be labeled as “out of tunnel”. Thus, the AI model learns to identify patterns and relationships between the raw data (e.g., GNSS signal metrics) and its corresponding labels. In some embodiments, during training, the AI model may adjust one or more internal parameters to reduce the difference between the inferred classification and the assigned labels.

FIG. 2C illustrates an area of the image within the bounding box 294 that may include a tunnel (e.g., tunnel #1). Accordingly, the data points (e.g., P1, P2, P3, P4) that correspond to locations inside of the bounding box 294 (representing the tunnel area) may be assigned the label “in tunnel” during the image data labeling. Further, during a training phase of the AI-based tunnel detection model 197, the features related to GNSS signal metrics that correspond to the data points (e.g., P1, P2, P3, P4) which are calculated in an epoch may be classified as “in tunnel”. As a result of image data labeling, the AI-based tunnel detection model 197 may be trained to classify locations as “in tunnel” or “out of tunnel” on new, unlabeled data to implement the AI-based tunnel detection functions, as disclosed herein.

FIG. 3A is a flowchart illustrating aspects of a method 300 of implementing AI-based tunnel detection for a wireless device utilizing GNSS, according to some embodiments of the present disclosure. Although FIG. 3A illustrates various operations in a method of implementing AI-based tunnel detection for a wireless device, embodiments according to the present disclosure are not limited thereto, and according to various embodiments, the method may include additional operations or fewer operations, or the order of operations may vary, unless otherwise stated or implied, without departing from the spirit and scope of embodiments according to the present disclosure. In some embodiments, the method 300 may be implemented by the tunnel detection circuit 195 including the AI-based tunnel detection circuitry 196 as described in greater detail in reference to FIG. 2A.

The method 300 may start at operation 305 by initiating and/or performing tunnel detection operations. For example, a mobile device, GPS navigation system of a vehicle, or other GNSS equipped device may utilize tunnel detection for determining if the device (e.g., GNSS receiver) has entered, is traveling through, or is exiting a tunnel. By initiating tunnel detection in operation 305, the device may utilize the method 300 in order to generate an initial determination of whether the device is positioned within a tunnel where the satellite signals may be blocked and/or severely degraded, and may adjust the operations of GNSS-based applications as deemed suitable and/or appropriate.

In some embodiments, operation 305 may involve performing tunnel detection operations that are not utilizing AI-based capabilities and/or functions. For example, the device may have AI-based tunnel detection capabilities disabled, or may be configured to perform AI-based tunnel detection in addition to and/or in lieu of the AI tunnel detection (non-AI) operations. In executing various tunnel detection (non-AI) to generate the initial determination, operation 305 may include performing tunnel detection operations that are based on real-time monitoring of GNSS signal quality (e.g., monitoring raw GNSS data). For example, the tunnel detection that is performed in operation 305 may involve monitoring GNSS signal strength (e.g., carrier-to-noise density ratio), monitoring the satellite visibility count, monitoring position fix type, and/or the like. Based on static rules, policies, and defined thresholds that are associated with the tunnel detection (non-AI) operations, an initial determination for tunnel detection may be generated in operation 305.

Thereafter, the method 300 may continue to execute tunnel detection operations after the initial determination of operation 305, for instance continuing tunnel detection to perform updated determination(s) in on-going phases as time progresses and the device continues to move and/or change position, potentially still moving through the tunnel or structure. For example, updated determination(s) in tunnel detection may be utilized for various tunnel detection phases and/or functions, including, but not limited to: exit detection; inside tunnel (maintained) detection, re-acquisition of GNSS signals; position re-synchronization; speed variations; and/or the like. In some embodiments, method 300 continues to perform tunnel detection (non-AI) operations for the updated determinations for continued tunnel detection, for example proceeding to operation 310 or operation 330 for executing one or more AI tunnel detection (non-AI) operations. The method 300 may execute AI-based tunnel detection operations, as disclosed herein, after the initial determination in operation 305 in order to continue tunnel detection using AI capabilities in manner that may improve the accuracy and/or efficiency of the method 300 in GNSS applications where navigation failures and/or inaccurate positioning (within a tunnel) can pose significant safety risks. In executing AI-based tunnel detection operations for the updated determination(s) the process 300 may proceed to operation 355.

In operation 310, a conditional check may be performed to determine if the GNSS signals are experiencing a signal variation. As used herein, a “signal variation” or “drop” in the GNSS signal or may refer to a substantial decrease in the strength (e.g., power) of the GNSS signal and/or a degradation, decrease, or measurable impact to other parameters that may be related to the quality of the GNSSS signal. For example, operation 310 can involve comparing the raw data from real-time acquisitions of GNSS signals to a signal variation threshold (e.g., signal strength variation threshold). As an example, a signal variation threshold can be set to a value of approximately 5 dB-Hz, and if the monitored strength of a GNSS signal (e.g., C/N0) has a delta (e.g., decreases) of a value that is greater than (or equal to) the signal variation threshold for a set time period (e.g., 1 second) then it may be determined that there is a detected signal variation (e.g., ΔGNSS signal strength≥5 dB-Hz/sec). For instance, detecting a signal variation in operation 310 can be indicative of a

relatively rapid and/or substantial drop of the strength of one or more GNSS signals (e.g., in relation to the GNSS signal strength seconds prior) that may be due to entering a tunnel. If there are no signal variations in the GNSS signals that are detected in operation 310 (“No”), then the method 300 can continue to operation 325 where it is determined that the device is remaining inside of the tunnel. If a signal variation of one or more of the GNSS signals is detected in operation 310 (“Yes”), then the method continues to operation 315.

In operation 315, a conditional check is performed to determine if a low GNSS signal strength is detected. For example, operation 315 can involve comparing the raw data from real-time acquisitions of GNSS signals to a low GNSS signal strength threshold (e.g., carrier-to-noise density ratio threshold). As an example, a low GNSS signal strength threshold can be set to a value of approximately 21 dB-Hz, and a determination of low strength may be ascertained if a measurement of the strength (C/N0) of an obtained GNSS signal is less than (or equal to) 21 dB-Hz (e.g., measured GNSS signal strength≤21 dB-Hz). If it is determined that the GNSS signal strength is not above the low GNSS signal strength threshold in operation 310 (“No”), the method 300 can continue to operation 325 where it is determined that the device is remaining inside of the tunnel. If the GNSS signal strength is above the low GNSS signal strength threshold in operation 315 (“Yes”), then the method continues to operation 320 where it is determined that the device may be exiting the tunnel (e.g., the device is experiencing stronger GNSS signals). In some embodiments, operations 310-325 may be performed iteratively, for example repeating for set period of time, a set number of iterations, or until the tunnel detection determines that the device is exiting the tunnel (e.g., set GNSS signal strength).

Returning to operation 330, a conditional check may be performed to determine if the GNSS signals are experiencing a signal variation. In some embodiments, operation 330 can involve functions that are substantially similar to those described in operation 310 above. For example, operation 330 can involve comparing the raw data from real-time acquisitions of GNSS signals to a signal variation threshold (e.g., signal strength variation threshold). As an example, a signal variation threshold can be set to a value of approximately 5 dB-Hz, and if the monitored strength of a GNSS signal (e.g., C/N0) has a delta (e.g., decreases) of a value that is greater than (or equal to) the signal variation threshold for a set time period (e.g., 1 second) then it may be determined that there is a detected signal variation (e.g., ΔGNSS signal strength≥5 dB-Hz/sec). If there is no signal variation in the GNSS signals that is detected in operation 330 (“No”), the method 300 can continue to operation 350 where it is determined that the device is not in the tunnel. If operation 330 detects that one or more GNSS signals are experiencing a signal variation (“Yes”) then the method continues to operation 335.

In operation 335, a conditional check is performed to determine if there is a set number of satellites being used for acquiring GNSS signals. For example, operation 335 can involve comparing the raw data from real-time acquisitions of GNSS signals to a defined satellite threshold (e.g., minimum number of satellites used threshold). As an example, a satellite threshold can be set to a value of approximately 5 (number of satellites), and a determination of a variation in the number of satellites can be ascertained if a measurement of the number of tracked satellites used by the device (e.g., number of satellites the device is receiving GNSS signals from) is less than (or equal to) 5 (e.g., number of satellites≤5). For instance, if a device is using a number of satellites that is less than the defined satellite threshold in order to calculate its position, velocity, and time solution, it may be indicative that the device may be in a tunnel and not receiving an amount of GNSS data that is appropriate for position tracking and can be susceptible to inaccuracies. If it is determined that the number of satellites being used at the device's current position is not lower than the satellite threshold in operation 335 (“No”), the method 300 can continue to operation 350 where it is determined that the device is not in the tunnel. If it is determined that the number of satellites being used at the device's current position is lower than the satellite threshold in operation 335 (“Yes”), then the method continues to operation 340 to continue with tunnel detection operations.

In operation 340, a conditional check is performed to determine if a low GNSS signal strength is detected. In some embodiments, operation 330 can involve functions that are substantially similar to those described in operation 315 above. For example, operation 340 can involve comparing the raw data from real-time acquisitions of GNSS signals to a low GNSS signal strength threshold (e.g., carrier-to-noise density ratio threshold). As an example, a low GNSS signal strength threshold can be set to a value of approximately 21 dB-Hz, and a determination of low strength may be ascertained if a measurement of the strength (C/N0) of an obtained GNSS signal is less than (or equal to) 21 dB-Hz (e.g., measured GNSS signal strength≤21 dB-Hz). If it is determined that the GNSS signal strength is not low (e.g., above the low GNSS signal strength threshold) in operation 340 (“No”), the method 300 can continue to operation 350 where it is determined that the device is not inside of the tunnel (e.g., the device is experiencing stronger GNSS signals). If the GNSS signal strength is determined to be low (e.g., lower than the low GNSS signal strength threshold) in operation 340 (“Yes”), then the method 300 continues to operation 345 where it is determined that is device may be entering in a tunnel. In some embodiments, operations 330-350 may be performed for the initial determination of tunnel detections, for example at a time associated with the initial stages of tunnel detection to determine if the device is starting to enter a tunnel.

At operation 355, the method 300 may perform AI-based tunnel detection operations, as disclosed herein, to determine whether the device is traveling through a tunnel (e.g., “in tunnel”). In some embodiments, operation 355 involves applying one or more AI-based models trained for tunnel detection (e.g., see FIG. 2B) to raw data from real-time acquisitions of GNSS signals and/or other data pertaining to tunnel detection (e.g., device positioning, speed, and/or the like). For example, the AI-based models utilized in operation 355 may be trained utilizing a process (e.g., larger data sets, data from longer tunnels, etc.) that enhances the accuracy and/or efficiency of the tunnel detection results than the tunnel detection (non-AI) performed in operations 310-350 that does not leverage AI capabilities. In some embodiments, operation 355 leverages inference of the AI-based models to generate a prediction result that serves as the updated determination(s) for tunnel detection, for instance using AI-based capabilities to more accurately predict the position of the device with respect to the tunnel (while it is traversing the tunnel or structure) after the method 300 has initially determined that the device has entered a tunnel. In some embodiments, operation 355 may generate an AI-based predicted result as an initial determination and/or updated determination(s) of method 300 for the various stages of tunnel detection, for example generating an AI-based prediction of whether the device is entering a tunnel, is inside of a tunnel, exiting a tunnel, and/or the like. Accordingly, the method 300 may implement AI-based tunnel detection in a manner that may improve the accuracy and efficiency (e.g., improving the speed of tunnel entry detection and/or tunnel exit detection) of tunnel detection and further improve the overall performance of GNSS applications for mobile devices.

FIG. 3B is a flowchart illustrating aspects of another method 360 of implementing integrated AI-based tunnel detection for a wireless device utilizing GNSS, according to some embodiments of the present disclosure. Although FIG. 3B illustrates various operations in a method of implementing AI-based tunnel detection for a wireless device, embodiments according to the present disclosure are not limited thereto. For example, according to some embodiments, the AI-based tunnel detection method 360 may include additional operations or fewer operations, or the order of operations may vary, unless otherwise stated or implied, without departing from the spirit and scope of embodiments according to the present disclosure. In some embodiments, the method 360 may be implemented by the tunnel detection circuit 195 including the AI-based tunnel detection circuitry 196 as described in greater detail in reference to FIG. 2A.

The method 360 may involve performing tunnel detection operations that are based on real-time monitoring of GNSS signal quality (e.g., monitoring raw GNSS data) and executing those operations in parallel (e.g., concurrently) with AI-based based tunnel detection operations. Subsequently, the method 360 may involve utilizing the detection results from both sets of operations to determine the current position of a wireless device with respect to a tunnel (e.g., “in tunnel” or “out of tunnel”) and further to control the disabling and/or enabling of AI-based based tunnel detection operations. AI-based tunnel detection operations, as disclosed herein, may have a higher level of complexity and granularity (e.g., higher sensitivity to changes in data) in comparison to non-AI based tunnel detection operations, which can allow the AI-based operations to achieve faster detection and with improved performance and/or accuracy. However, there can be some trade-offs associated with utilizing AI-based tunnel detection. For example, there may be higher consumption of the computing resources of a wireless device (e.g., computing power, battery, storage, etc.) with using complex AI-based models (e.g., deep neural networks), and utilizing static GNSS signal quality metrics for non-AI based tunnel detection operations may have substantially lower consumption of the resources. By having the capability to dynamically disable and/or enable the AI-based tunnel detection operations, the method 360 may improve the overall accuracy (e.g., reduced false positives, etc.) and efficiency (e.g., reduced computational resource consumption) of tunnel detection for GNSS applications for a wireless device.

At operation 365, GNSS signals may be received for analysis related to tunnel detection operations. For example, a wireless device (e.g., UE) may have a GNSS receiver that processes signals that are received from GNSS satellites. The wireless device can ascertain data (e.g., GNSS data) from the received GNSS signals, which can be utilized to calculate position and/or movement related data (e.g., velocity, time, etc.). Operation 365 may include real-time acquisitions of GNSS signals in order to obtain raw data related to position and/or GNSS capabilities. Accordingly, GNSS signals and related data that are obtained in operation 365 may be utilized to implement tunnel detection (non-AI) operations for example tunnel detection the utilizes real-time monitoring of GNSS signal quality (e.g., monitoring raw GNSS data). The GNSS signals and related data that are obtained in operation 365 may also be applied to execute AI-based tunned detection operations, as disclosed herein. In some embodiments, the GNSS signals and related data obtained in operation 365 may be utilized for various functions executed by the hardware implementing AI-based tunnel detection (e.g., tunnel detection circuit 195), including: calculations and/or determinations related to GNSS signal metrics and/or quality (e.g., carrier-to-noise density ratio, satellite visibility count, signal power, position fix type, average satellite signal strength, etc.); calculations and/or determinations related to sensor measurements (accelerometers, gyroscopes, etc.); calculations and/or measurements related to position, motion, and/or orientation of the wireless device (e.g., speed/acceleration, angular velocity, etc.); calculations and/or measurements related to time and/or temporal parameters (e.g., time inside of tunnel, etc.); tunnel detection (non-AI) operations based on rules, defined thresholds, policies, etc. ; and/or the like. In some embodiments, GNSS signals received in operation 365 can also be utilized to execute other applications and/or functions that may provide navigation, device position, and/or device movement features that are supported using GNSS technology, for example, GPS navigation.

At operation 366, AI-based tunnel detection operations may be executed, as disclosed herein, to determine whether the device is traveling through a tunnel (e.g., “in tunnel”). In some embodiments, operation 366 may involve applying one or more AI-based models trained for tunnel detection (e.g., see FIG. 2B) to the data obtained from received GNSS signals (in previous operation 365). In some embodiments, AI-based tunnel detection operations may involve repeatedly running the AI-based model(s) at relatively short time intervals to generate a prediction (or classification) of the wireless device with respect to the tunnel, for instance an AI-based model may approximately generate an output per second. As an example, the AI-based tunnel detection operations can iteratively generate a classification of the current position for the wireless device, for instance classifying the device's current position as “in tunnel” or “out of tunnel” approximately each second using the AI-based model that has been trained to automatically and quickly classify observed GNSS signals and related data. For instance, data relating to the current signal strength of a GNSS signal that is acquired in real-time (at previous operation 365) may be applied to the AI-based model, then an “in tunnel” or “out of tunnel” classification may be inferred for the current position of the wireless device based on the model's learned inference between observed trends of GNSS signal characteristics with respect to its position to a tunnel.

At operation 367, tunnel detection (non-AI) operations may be executed, for example tunnel detection operations based on real-time monitoring of GNSS signal quality (e.g., monitoring raw GNSS data). Accordingly, the tunnel detection operations may utilize the acquisition of GNSS signals obtained in real-time to obtain raw data (indicative of the GNSS qualities and characteristics), and can apply static rules, defined thresholds, and policies to detect whether the wireless device is currently in a tunnel based on the real-time GNSS signals and raw data (e.g. weakening or loss of satellite signals as a tunnel entrance is approached). For example, tunnel detection (non-AI) operations that are executed at operation 367 may involve determining whether the strength and/or quality of GNSS signals has decreased by a determined amount (e.g., low GNSS signal strength), for instance using a defined threshold, in order to determine that the wireless device may be in a tunnel. In some embodiments, operation 367 may involve executing one or more of the steps of method 300 that include applying static rules, defined thresholds, and policies to detect whether the wireless device has entered a tunnel based on the real-time GNSS signals and raw data, as previously described in detail in reference to FIG. 3A. Then, based on the tunnel detection (non-AI) operations that are executed at operation 367, the method 360 may continue to operation 370.

At operation 370, a conditional check may be performed to determine whether the current position of the wireless device is determined to be inside of a tunnel or outside of a tunnel based on the tunnel detection (non-AI) operations (executed in previous operation 365), for example using the real-time monitoring of GNSS signal quality. In the case where the tunnel detection (non-AI) operations determine that the current position of the wireless is inside of a tunnel (“Yes” in FIG. 3B), the method 360 may generate an “in tunnel” detection result at operation 371. Alternatively in the case where the tunnel detection (non-AI) operations determine that the current position of the wireless is outside of a tunnel (“No” in FIG. 3B), the method 360 may generate an “out of tunnel” detection result at operation 372.

As an example, the tunnel detection (non-AI) operations that are executed at operation 367 may involve measuring the signal strength from raw data of real-time acquisitions of GNSS signals and comparing to a low GNSS signal strength threshold (e.g., carrier-to-noise density ratio threshold). If it is determined that the current GNSS signal strength is below the low GNSS signal strength threshold (e.g., approximately 21 dB-Hz), then the tunnel detection (non-AI) operations may determine that the wireless device may be in tunnel (indicated by the degraded strength of the signal due to potential obstruction) and the method 360 may continue to operation 371 where an “in tunnel” detection result is generated. If the measured GNSS signal strength is above the low GNSS signal strength threshold, then the tunnel detection (non-AI) operations may determine that the wireless device may be outside of the tunnel (indicated by the greater strength of the signal due and potential no obstruction), and the method 360 may continue to operation 372 where an “out of tunnel” detection result is generated.

In some embodiments, generating the “in tunnel” detection result at operation 371 may include performing functions that are integrated with other systems of the wireless device in order to maintain and/or provide positioning and navigation capabilities when GNSS signals are unavailable (e.g., blocked, attenuated, etc.) due to being obstructed by the tunnel. For example, generating the “in tunnel” detection result at operation 371 can trigger the wireless device to automatically perform estimation of the position of the wireless device without GNSS signals and/or to execute additional functions (e.g., enable cameras and/or other sensors) to continue GNSS applications, such as navigation, for the wireless device.

Method 360 may involve executing both forms of tunnel detection concurrently. Operation 366, which performs AI-based tunnel detection operations, and operation 367, which performs tunnel detection (non-AI) operations, may be iteratively executed together in order for the method 360 to generate a determination of the wireless device's current position with respect to a tunnel (e.g., “in tunnel” or “out of tunnel”) and to further control the disabling and/or enabling of AI-based based tunnel detection operations.

At operation 368, a conditional check may be performed to determine whether the AI-based tunnel detection operations (e.g., executed at previous operation 366) has classified the current position of the wireless device as being in a tunnel (e.g., “in tunnel”). If it is determined in operation 368 that the wireless device is not currently in a tunnel (“No”in FIG. 3B) then the method 360 may return to operation 366 and continue to iteratively execute AI-based tunnel detection operations. In some embodiments, the method 360 may wait until the tunnel detection (non-AI) operations (e.g., executed at previous operation 367) also detects that the wireless device is out of a tunnel before the method 360 proceeds to operation 372 and generate an “out of tunnel” detection result. In some embodiments, it may be possible for the method 360 to proceed to operation 372 (from operation 368) and generate an “out of tunnel” detection result based on the AI-based tunnel detection operations classifying the current position of the wireless device as “out of tunnel” (“No” in FIG. 3B) without confirming and/or waiting on the results from tunnel detection (non-AI) operations (e.g., executed at previous operation 367).

Returning to operation 368, if it is determined that the AI-based tunnel detection operations (e.g., executed in previous operation 366) have classified the wireless device's current position as being in a tunnel (“Yes”in FIG. 3B) then the method 360 may continue to operation 369.

At operation 369, a conditional check can be performed to compare results of the AI-based tunnel detection operations (e.g., executed at previous operation 366) to the results of tunnel detection (non-AI) operations, for instance based on real-time monitoring of GNSS signal quality, that are running concurrently (e.g., executed in previous operation 367) in the method 360. If it is determined in operation 369 based on the comparison that both of the results from the AI-based tunnel detection operations (e.g., executed at previous operation 366) and the tunnel detection (non-AI) operations (e.g., executed in previous operation 367) have detected that the wireless device is currently in a tunnel (“Yes” in FIG. 3B), then there is convergence between the two functions and the method 360 may proceed to operation 371 and generate an “in tunnel” detection result from the method 360.

For example, in some cases, a wireless device may initially detect it is currently entering (or recently just entered) a tunnel using the AI-based tunnel detection operations executed at operation 366, as disclosed herein, which may have a faster and more reactive detection response for the device's current position. The wireless device can delay any fail-safe functions (e.g., enabling cameras and/or other sensors to perform position estimation without GNSS signals that may be blocked) until after the result comparison in operation 369, where it is determined that the tunnel detection (non-AI) operations (executed at operation 367) have also detected that the wireless device is currently in the tunnel, for example based on the loss of quality of GNSS signals during real-time acquisition (which may not be measurable until after a time period has lapsed inside of the tunnel). Then, sometime after operation 368 determines the initial “in tunnel” detection by the AI-based tunnel detection operations, the method 360 can generate the “in tunnel” detection result at operation 371.

As disclosed herein, the AI-based tunnel detection operations executed in operation 366 may have an increased speed with respect to tunnel entry detection and/or tunnel exit detection as compared to the tunnel detection (non-AI) operations executed in operation 367. Thus, in cases where the tunnel detection (non-AI) operations executed in operation 367 produce an “in tunnel” detection result in operation 371 or the “out of tunnel” detection result in operation 372, it may be after the AI-based detection operations (executed at previous operation 366) have already detected the tunnel entry or tunnel exit for the wireless device, respectively, due to the enhanced capabilities of AI-based techniques. Accordingly, in some embodiments, generating an “in tunnel” detection result at operation 371 can also involve dynamically disabling the AI-based tunnel detection operations for a set amount of time (e.g., temporarily disable for approximately 60 seconds), as there is a high likelihood that the AI-based tunnel detection operations have already detected the tunnel. In this case, the method 360 may utilize the enhance capabilities of AI-based tunnel detection operation to quickly detect when the wireless device has entered the tunnel, but can continue executing tunnel detection (non-AI) operations (e.g., while AI-based tunnel detection operations are temporarily disabled), for example detecting the wireless device continuing to travel through the tunnel until it exits the tunnel. Furthermore, by temporarily disabling the AI-based tunnel detection operations, errors and/or unintended functions may be mitigated, such as the lower the rate of false positives for “in tunnel” detection results that may be experience with AI-based tunnel detection operations.

In some embodiments, generating an “out of tunnel” detection result at operation 372 can also involve dynamically disabling the AI-based tunnel detection operations for a set time (e.g., temporarily disable for approximately 60 seconds), as there is a high likelihood that the AI-based tunnel detection operations have already detected exiting the tunnel. For example, the tunnel detection (non-AI) operations (executed at previous operation 367) may generate an “out of tunnel” detection result at operation 372, and after a set time period (e.g., approximately 10 seconds) from detecting the wireless device being out of the tunnel, the AI-based tunnel detection operations may be disabled. By temporarily disabling the AI-based tunnel detection operations, errors and/or unintended functions may be mitigated, such as AI-based tunnel detection operations quickly “re-detecting” the tunnel before the wireless device has time for reacquisition of the GNSS signal(s) after exiting the tunnel.

Furthermore, after the AI-based tunnel detection operations have been temporarily disabled for the set amount of time, the method 360 can automatically enable the AI-based tunnel detection operations. For example, after the method 360 generates the “out of tunnel” detection result at operation 372 which causes the AI-based tunnel detection operations to be temporarily disabled for a set amount of time. After the time period for temporary disablement has expired, for example approximately 60 seconds after its has been detected that the wireless device has exited the tunnel, the method 360 can again enable exaction of the AI-based tunnel detection operations, as disclosed herein.

Thus, the method 360 can execute tunnel detection operations in a manner that may improve the efficiency of the wireless device (e.g., lower consumption of resources related to executing the AI-based tunnel detection operations) and may improve the overall performance (e.g., lowering the rate of false positives) by integrating the execution of AI-based tunnel operations with other tunnel detection (non-AI) operations and by dynamically enabling and/or disabling the AI-based tunnel detection operations based on operational conditions when AI capabilities may be optimally leveraged.

FIG. 3C is a flow chart illustrating aspects of another example method 380 of integrating AI-based tunnel detection for a wireless device utilizing GNSS, according to some embodiments of the present disclosure. Although FIG. 3C illustrates various operations in a method of implementing AI-based tunnel detection for a wireless device, embodiments according to the present disclosure are not limited thereto, and according to various embodiments, the method may include additional operations or fewer operations, or the order of operations may vary, unless otherwise stated or implied, without departing from the spirit and scope of embodiments according to the present disclosure. In some embodiments, the method 380 may be implemented by the tunnel detection circuit 195 including the AI-based tunnel detection circuitry 196 as described in greater detail in reference to FIG. 2A.

At operation 381, a first satellite signal may be received. The first satellite signal may be transmitted to a UE device from a GNSS satellite. Accordingly, the first satellite signal may be a GNSS signal. The first satellite signal may be related to a first position of a UE device. For example, a GNSS signal can be received as first satellite signal as the UE has a first position relating to the UE initially entering a tunnel, and where the GNSS signal may be used for supporting a GPS navigation application executing on the UE device.

At operation 382, an AI model may be applied based on the first satellite signal in order to generate a tunnel detection result. The tunnel detection result may be generated by the AI model in a manner that is associated with the first position of the UE device. For example, the AI model may be applied to the GNSS signal (e.g., first satellite signal) received at a current position (e.g., first position) of the UE device to generate a tunnel detection result which determines the current position (e.g., first position) of the UE device with respect to a tunnel that may obstruct a line-of-sight to the GNSS satellite. In some embodiments, applying the AI model based on the first satellite signal in operation 382 may be implemented as AI-based tunnel detection operations, as disclosed herein, for example in reference to FIGS. 3A-3B. For instance, data associated with the received GNSS signal (e.g., first satellite signal) may be applied to the AI model that is trained to predict whether the position of UE device is inside of a tunnel (e.g., “in tunnel”) based on GNNS signal metrics for the first satellite signal, or outside of a tunnel (e.g., “out of tunnel”) based on the GNNS signal metrics for the first satellite signal. Referring back to the example of operation 381, if the GNSS signal can be received as the first satellite signal as the UE has a first position relating to the UE initially entering a tunnel, the AI model may be applied to the metrics related to the GNSS signal in order to classify the first position of the UE device as “in tunnel” (with respect to the tunnel) as the tunnel detection result.

At operation 383, the tunnel detection result (generated in previous operation 382) may be compared to a value generated based on the first satellite signal. The value may correspond to an output from a tunnel detection operation performed based on applying a threshold to the first satellite signal. For example, the value may represent an output (e.g., result) of tunnel detection performed based on applying defined threshold(s), rules, and/or policies to the first satellite signal. In some embodiments, the value may be the result of non-AI based tunnel detection operations that may be executed on the first satellite signal, for example tunnel detection operations based on real-time monitoring of the GNSS signal quality (e.g., monitoring raw GNSS data), as disclosed herein, for example described in reference to FIGS. 3A-3B . As an example, tunnel detection based on applying static rules, defined thresholds, and policies (e.g., real-time GNSS signals and raw data) can involve determining whether the strength and/or quality of the GNSS signal (e.g., first satellite signal) has decreased by a determined amount (e.g., low GNSS signal strength), for instance using a defined threshold, in to generate the value (e.g., representing a tunnel detection result) indicating that the UE device may be in a tunnel. In some embodiments, the value may be set to a first integer (e.g., “1”) which can be defined to represent the tunnel detection result of “in tunnel” and the value may be set to a first integer (e.g., “1”) which can be defined to represent the tunnel detection result of “out of tunnel”. Accordingly, operation 383 may involve comparing the results of AI-based tunnel detection operations (e.g., tunnel detection result) and the results of non-AI based tunnel operations (e.g., the value correspond to an output from a tunnel detection operation) to determine whether the tunnel detection results converge (e.g., both indicating “in tunnel” or “out of tunnel”) or diverge (indicating opposing positions with respect to the tunnel). In some embodiments, the comparing executed in operation 383 may be implemented including one or more functions involved in the tunnel prediction result comparison (e.g., conditional check operation) disclosed herein, for example described in reference to FIG. 3B.

At operation 384, determining to disable or enable applying the AI model to a second satellite signal based on the comparing (at previous operation 383) may be performed. The second satellite signal may be received by the UE device at a time instance occurring after the UE has received the first satellite signal, and the second satellite signal may be related to a second position of the UE at a later time relative to the first position of the UE. For example, the second position may correspond to the UE device currently being positioned inside of the tunnel after the first position of the UE was previously corresponding to initially entering the tunnel. The comparison indicating that the value (e.g., correspond to an output from a tunnel detection operation based on a threshold) and the tunnel detection result (e.g., generated by applying the AI model) both correspond to an “in tunnel” detection result may cause operation 384 to determine to dynamically disable applying the AI model to the second satellite signal, for instance temporarily disabling the AI-based tunnel detection operations for a set amount of time (e.g., temporarily disable for approximately 60 seconds), as there is a high likelihood that the AI-based tunnel detection operations have already detected the tunnel. Determining to enable applying the AI model to the second satellite signal in operation 384 may be based on the comparing indicating a divergence of the tunnel detection result and the value. In some embodiments, determining to enable and/or disable applying the AI model to the second satellite signal may be implemented as one or more functions involved in dynamically disabling and/or enabling the AI-based tunnel detection operations, as disclosed herein, for example in reference to FIG. 3B.

At operation 385, a function of the UE device may be executed to perform estimation of the first position of the UE device based on generated tunnel detection result. For example, in response to detecting that the current position (e.g., first position) of the UE device is inside of a tunnel (e.g., based on AI-based tunnel detection operations) settings of the UE device may be automatically adjusted in order to continue performing estimation of the first position of the UE device without GNSS signals (which may be blocked and/or degraded by the tunnel) by enabling other electromechanical sensors and/or systems of the UE device (e.g., accelerometers, gyroscopes, etc.). Accordingly, the UE device may be configured to execute fail-safe operations that are integrated with (e.g., triggered by) the AI-based tunnel detection operations, thereby allowing the UE device to continue to utilize GNSS-based applications, such as GPS navigation, although the GNSS signals may be temporarily obstructed as the UE device is inside of a tunnel. Thus, method 380 may implement an integrating of AI-based tunnel detection, including dynamic enabling and/or disabling of the AI-based tunnel detection operations, in a manner that may improve the efficiency, accuracy and/or overall performance of GNSS-based applications, such as GPS navigation.

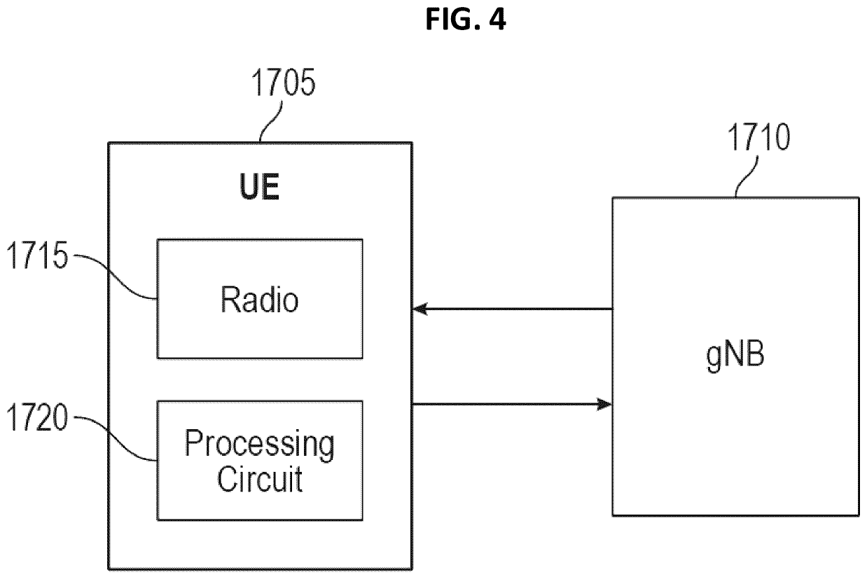

FIG. 4 illustrates a system including an electronic device, for example, a UE 1705 (e.g., see UR 190 of FIG. 1) implementing AI-based tunnel detection, according to some embodiments of the present disclosure. FIG. 4 illustrates a system including a UE 905 and a gNB 910 in communications with each other.

FIG. 4 shows a system including a UE 1705 and a gNB 1710, in communication with each other. The UE 1705 may include a radio 1715 and a processing circuit (or a means for processing) 1720, which may perform various functions for AI-based tunnel detection, as disclosed herein. For example, the UE 1705 may implement the structure and functions of UE 190 as described in reference to FIG. 1. The processing circuit 1720 may receive, via the radio 1715, transmissions from the network node (gNB) 1710, and the processing circuit 1720 may transmit, via the radio 1715, signals to the gNB 1710.

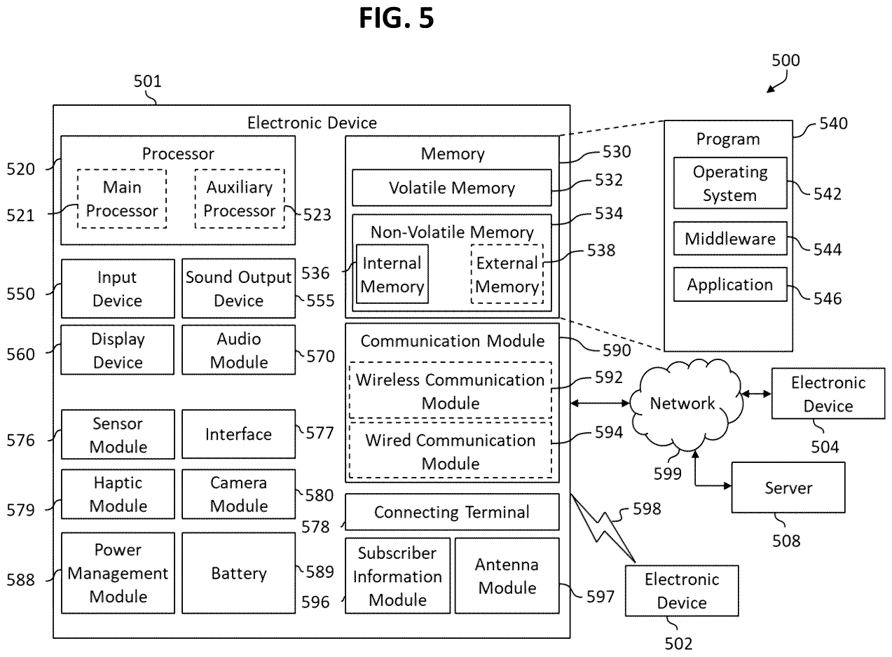

FIG. 5 is a block diagram of an electronic device in a network environment, according to some embodiments of the present disclosure. In some embodiments, the electronic device 501 may be implemented as the UE device 190 including the tunnel detection circuit 195 and AI-based tunnel detection circuitry 196, as disclosed herein. However, there are embodiments according to the present disclosure that are not limited thereto. For example, according to some embodiments, electronic device 501 may be implemented as various other wireless devices, mobile devices, vehicles, and/or other GNSS-equipped devices, without departing from the spirit and scope of embodiments according to the present disclosure.

Referring to FIG. 5, an electronic device 501 in a network environment 500 may communicate with an electronic device 502 via a first network 598 (e.g., a short-range wireless communication network), or with an electronic device 504 or a server 508 via a second network 599 (e.g., a long-range wireless communication network). The electronic device 501 may communicate with the electronic device 504 via the server 508. The electronic device 501 may include a processor 520, a memory 530, an input device 550, a sound output device 555, a display device 560, an audio module 570, a sensor module 576, an interface 577, a haptic module 579, a camera module 580, a power management module 588, a battery 589, a communication module 590, a subscriber identification module (SIM) card 596, and/or an antenna module 597. In one embodiment, at least one of the components (e.g., the display device 560 or the camera module 580) may not be provided from the electronic device 501, or one or more other components may be added to the electronic device 501. Some of the components may be implemented as a single integrated circuit (IC). For example, the sensor module 576 (e.g., a fingerprint sensor, an iris sensor, or an illuminance sensor) may be embedded in the display device 560 (e.g., a display).

The processor 520 may execute software (e.g., a program 540) to control at least one other component (e.g., a hardware or a software component) of the electronic device 501 coupled to the processor 520, and may perform various data processing or computations. For example, the processor 520 may execute instructions to perform methods disclosed in FIGS. 3 and 4.

As at least a part of the data processing or computations, the processor 520 may load a command or data received from another component (e.g., the sensor module 576 or the communication module 590) in volatile memory 532, may process the command or the data stored in the volatile memory 532, and may store resulting data in non-volatile memory 534. The processor 520 may include a main processor 521 (e.g., a central processing unit or an application processor (AP)), and an auxiliary processor 523 (e.g., a graphics processing unit (GPU), an image signal processor (ISP), a sensor hub processor, or a communication processor (CP)) that is operable independently from, or in conjunction with, the main processor 521. Additionally or alternatively, the auxiliary processor 523 may be adapted to consume less power than the main processor 521, or to execute a particular function. The auxiliary processor 523 may be implemented as being separate from, or a part of, the main processor 521.

The auxiliary processor 523 may control at least some of the functions or states related to at least one component (e.g., the display device 560, the sensor module 576, or the communication module 590), as opposed to the main processor 521 while the main processor 521 is in an inactive (e.g., sleep) state, or together with the main processor 521 while the main processor 521 is in an active state (e.g., executing an application). The auxiliary processor 523 (e.g., an image signal processor or a communication processor) may be implemented as part of another component (e.g., the camera module 580 or the communication module 590) functionally related to the auxiliary processor 523.

The memory 530 may store various data used by at least one component (e.g., the processor 520 or the sensor module 576) of the electronic device 501. The various data may include, for example, software (e.g., the program 540) and input data or output data for a command related thereto. The memory 530 may include the volatile memory 532 or the non-volatile memory 534.

The program 540 may be stored in the memory 530 as software, and may include, for example, an operating system (OS) 542, middleware 544, or an application 546.

The input device 550 may receive a command or data to be used by another component (e.g., the processor 520) of the electronic device 501, from the outside (e.g., a user) of the electronic device 501. The input device 550 may include, for example, a microphone, a mouse, or a keyboard.

The sound output device 555 may output sound signals to the outside of the electronic device 501. The sound output device 555 may include, for example, a speaker or a receiver. The speaker may be used for general purposes, such as playing multimedia or recording, and the receiver may be used for receiving an incoming call. The receiver may be implemented as separate from, or as a part of, the speaker.

The display device 560 may visually provide information to the outside (e.g., to a user) of the electronic device 501. The display device 560 may include, for example, a display, a hologram device, and/or a projector, and may include control circuitry to control a corresponding one of the display, the hologram device, and/or the projector. The display device 560 may include touch circuitry adapted to detect a touch, and/or may include sensor circuitry (e.g., a pressure sensor) adapted to measure the intensity of force incurred by the touch.

The audio module 570 may convert a sound into an electrical signal and vice versa. The audio module 570 may obtain the sound via the input device 550 and/or may output the sound via the sound output device 555 or a headphone of an external electronic device 502 directly (e.g., wired) or wirelessly coupled to the electronic device 501.

The sensor module 576 may detect an operational state (e.g., power or temperature) of the electronic device 501, and/or an environmental state (e.g., a state of a user) external to the electronic device 501. The sensor module 576 may then generate an electrical signal and/or a data value corresponding to the detected state. The sensor module 576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor.

The interface 577 may support one or more specified protocols to be used for the electronic device 501 to be coupled to the external electronic device 502 directly (e.g., wired) or wirelessly. The interface 577 may include, for example, a high-definition multimedia interface (HDMI), a universal serial bus (USB) interface, a secure digital (SD) card interface, and/or an audio interface.

A connecting terminal 578 may include a connector via which the electronic device 501 may be physically connected to the external electronic device 502. The connecting terminal 578 may include, for example, an HDMI connector, a USB connector, an SD card connector, and/or an audio connector (e.g., a headphone connector).

The haptic module 579 may convert an electrical signal into a mechanical stimulus (e.g., a vibration or a movement) and/or an electrical stimulus, which may be recognized by a user via tactile sensation or kinesthetic sensation. The haptic module 579 may include, for example, a motor, a piezoelectric element, and/or an electrical stimulator.

The camera module 580 may capture a still image and/or moving images. The camera module 580 may include one or more lenses, image sensors, image signal processors, and/or flashes. The power management module 588 may manage power that is supplied to the electronic device 501. The power management module 588 may be implemented as at least a part of, for example, a power management integrated circuit (PMIC).

The battery 589 may supply power to at least one component of the electronic device 501. The battery 589 may include, for example, a primary cell that is not rechargeable, a secondary cell that is rechargeable, and/or a fuel cell.

The communication module 590 may support establishing a direct (e.g., wired) communication channel and/or a wireless communication channel between the electronic device 501 and the external electronic device (e.g., the electronic device 502, the electronic device 504, and/or the server 508), and may support performing communication via the established communication channel. The communication module 590 may include one or more communication processors that are operable independently from the processor 520 (e.g., the AP), and may support a direct (e.g., wired) communication and/or a wireless communication. The communication module 590 may include a wireless communication module 592 (e.g., a cellular communication module, a short-range wireless communication module, and/or a global navigation satellite system (GNSS) communication module) and/or a wired communication module 594 (e.g., a local area network (LAN) communication module or a power line communication (PLC) module). A corresponding one of these communication modules may communicate with the external electronic device via the first network 598 (e.g., a short-range communication network, such as BLUETOOTH™, wireless-fidelity (Wi-Fi) direct, and/or a standard of the Infrared Data Association (IrDA)), or via the second network 599 (e.g., a long-range communication network, such as a cellular network, the Internet, and/or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 592 may identify and authenticate the electronic device 501 in a communication network, such as the first network 598 and/or the second network 599, utilizing subscriber information (e.g., international mobile subscriber identity (IMSI)) stored in the subscriber identification module 596.

The antenna module 597 may transmit or receive a signal and/or power to or from the outside (e.g., the external electronic device) of the electronic device 501. The antenna module 597 may include one or more antennas. The communication module 590 (e.g., the wireless communication module 592) may select at least one of the one or more antennas appropriate for a communication scheme used in the communication network, such as the first network 598 and/or the second network 599. The signal and/or the power may then be transmitted and/or received between the communication module 590 and the external electronic device via the selected at least one antenna.

Commands or data may be transmitted and/or received between the electronic device 501 and the external electronic device 504 via the server 508 coupled to the second network 599. Each of the electronic devices 502 and 504 may be a device of a same type as, or a different type, from the electronic device 501. All or some of operations to be executed at the electronic device 501 may be executed at one or more of the external electronic devices 502 or 504, or server 508. For example, if the electronic device 501 should perform a function or a service automatically, or in response to a request from a user or another device, the electronic device 501, instead of, or in addition to, executing the function or the service, may request the one or more external electronic devices to perform at least a part of the function or the service. The one or more external electronic devices receiving the request may perform the at least a part of the function or the service requested, or an additional function or an additional service related to the request and transfer an outcome of the performing to the electronic device 501. The electronic device 501 may provide the outcome, with or without further processing of the outcome, as at least a part of a reply to the request. To that end, cloud computing, distributed computing, and/or client-server computing technology may be utilized, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively, or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the exemplary embodiments of the present invention.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims, and their equivalents.

What is claimed is:

1. A method, comprising:
receiving, at a user equipment (UE) device, a first satellite signal, wherein the first satellite signal is related to a first position of the UE device;
applying an Artificial intelligence (AI) model based on the first satellite signal to generate a tunnel detection result corresponding to the first position of the UE device;
comparing the tunnel detection result to a value generated based on the first satellite signal;
determining to disable or enable applying the AI model to a second satellite signal based on the comparing, wherein the second satellite signal is received by the UE device and related to a second position of the UE device; and
executing a function of the UE device to perform estimation of the first position of the UE device based on the tunnel detection result.

2. The method of claim 1, wherein the value corresponds to an output from a tunnel detection operation performed based on applying a threshold to the first satellite signal; and
further wherein the tunnel detection result corresponds to classifying the first position of the UE device as inside of a tunnel or corresponds to classifying the first position of the UE device as outside of the tunnel based.

3. The method of claim 2, wherein determining to disable applying the AI model to the second satellite signal is based on the comparing indicating a convergence of the tunnel detection result and the value.

4. The method of claim 3, wherein the AI model is trained on a plurality of Global Navigation Satellite System (GNSS) signal metrics related to the first satellite signal, and the GNSS signal metrics comprise one or more L1 GNSS signal metrics and one or more L5 GNSS signal metrics.

5. The method of claim 3, wherein the first satellite signal and the second satellite signal comprise a Global Navigation Satellite System (GNSS) signal transmitted from a satellite.

6. The method of claim 1, wherein the AI model is trained to classify stages of tunnel detection corresponding to the first position of the UE device, the stages of tunnel detection comprising one or more of: entering a tunnel, inside of a tunnel, and exiting a tunnel.

7. The method of claim 1, wherein the first satellite signal and the second satellite signal are related to a Global Navigation Satellite System (GNSS) application of the UE device.

8. The method of claim 7, wherein the GNSS application of the UE device comprises Global Positioning System (GPS) navigation.

9. The method of claim 8, further comprising
executing an additional function of the UE device to perform GPS navigation using a camera of the UE device or a sensor of the UE device based on the tunnel detection result indicating the first position of the UE device corresponds to inside of a tunnel.

10. The method of claim 3, wherein determining to enable applying the AI model to the second satellite signal is based on the comparing indicating a divergence of the tunnel detection result and the value.

11. The method of claim 2, wherein the threshold comprises a set number of satellites used to transmit the first satellite signal.

12. The method of claim 10, wherein the threshold comprises a set signal strength of the first satellite signal.

13. A device, comprising:
a processor; and
a memory storing instructions that, based on being executed by the processor, cause the processor to:
receive a first satellite signal, wherein the first satellite signal is related to a first position of a the device;
apply an Artificial intelligence (AI) model based on the first satellite signal to generate a tunnel detection result corresponding to the first position of the device;
compare the tunnel detection result to a value generated based on the first satellite signal;
determine to disable or enable applying the AI model to a second satellite signal based on the comparing, wherein the second satellite signal is received by the device and related to a second position of the device; and
execute a function of the device to perform estimation of the first position of the device based on the tunnel detection result.

14. The device of claim 13, wherein the device comprises a User Equipment (UE) device.

15. The device of claim 14, wherein the value corresponds to an output from a tunnel detection operation performed based on applying a threshold to the first satellite signal; and further wherein the tunnel detection result corresponds to classifying the first position of the UE device as inside of a tunnel or corresponds to classifying the first position of the UE device as outside of the tunnel based.

16. The device of claim 15, wherein the AI model is trained on a plurality of Global Navigation Satellite System (GNSS) signal metrics related to the satellite signal.

17. The device of claim 16, wherein the GNSS signal metrics comprise one or more L1 GNSS signal metrics and one or more L5 GNSS signal metrics.

18. The device of claim 17, wherein the first satellite signal and the second satellite signal comprise a Global Navigation Satellite System (GNSS) signal transmitted from a satellite.

19. The device of claim 14, wherein the first satellite signal and the second satellite signal are related to a Global Navigation Satellite System (GNSS) application of the UE device.

20. A system, comprising:
a receiver communicating with a Global Navigation Satellite System (GNSS) satellite;
a processing circuit; and
a memory device storing instructions, which, based on being executed by the processing circuit, cause the processing circuit to perform:
receiving a first satellite signal, wherein the first satellite signal is related to a first position of a the device;
applying an Artificial intelligence (AI) model based on the first satellite signal to generate a tunnel detection result corresponding to the first position of the device;
comparing the tunnel detection result to a value generated based on the first satellite signal;
determining to disable or enable applying the AI model to a second satellite signal based on the comparing, wherein the second satellite signal is received by the device and related to a second position of the device; and
executing a function of the device to perform estimation of the first position of the device based on the tunnel detection result.
